(19) United States
(12) Patent Application Publication
(10) Pub. No.: US 2024/0200160 A1
(43) Pub. Date: Jun. 20, 2024

(54) HEAT TREATMENT FURNACE

(71) Applicant: KANTO YAKIN KOGYO CO., LTD., Hiratsuka-shi, Kanagawa (JP)

(72) Inventors: Shinichi TAKAHASHI, Hiratsuka-shi, Kanagawa (JP); Kensuke TAKAHASHI, Hiratsuka-shi, Kanagawa (JP); Kiichi KANDA, Hiratsuka-shi, Kanagawa (JP); Kosuke TAKAHARA, Hiratsuka-shi, Kanagawa (JP); Hiroshi OSHITA, Hiratsuka-shi, Kanagawa (JP)

(21) Appl. No.: 18/418,933

(22) Filed: Jan. 22, 2024

Related U.S. Application Data
(63) Continuation of application No. PCT/JP22/30911, filed on Aug. 15, 2022.

(30) Foreign Application Priority Data
Aug. 19, 2021 (JP) 2021-134222

(51) Int. Cl. C21D 9/00; C21D 11/00

(52) U.S. Cl. CPC C21D 9/0006; C21D 11/005

(57) ABSTRACT

In the present disclosure, a motor core can be degreased prior to straightening annealing without a heating device or a vacuum device dedicated to degreasing being provided. A heat treatment furnace according to an embodiment of the present disclosure includes a degreasing chamber for degreasing a motor core, a heating chamber with which the degreasing chamber directly communicates and which is configured to anneal the motor core that has passed through the degreasing chamber, by using a converted gas generated by a converted gas generation device, as an in-furnace atmosphere gas, and a gas flow formation section GF configured in such a manner that the converted gas in the heating chamber flows toward the degreasing chamber.

### CROSS-REFERENCE TO RELATED APPLICATION

This application is a continuation of International Application No. PCT/JP2022/030911, filed Aug. 15, 2022 which claims the benefit of priority of the prior Japanese Patent Application No. 2021-134222, filed Aug. 19, 2021. The contents of these applications are incorporated herein by reference in their entirety.

### TECHNICAL FIELD

The present disclosure relates to a heat treatment furnace and particularly to a heat treatment furnace for use in straightening annealing of a motor core.

### BACKGROUND ART

Hitherto, electrical steel sheets have been used in electrical apparatuses, for example, stationary devices such as transformers or rotary devices such as motors. For example, an iron core (core) of a motor is produced by die cutting a non-oriented electrical steel sheet of a predetermined thickness into a stator shape or a rotor shape with use of a die and laminating the die-cut sheets together.

However, in the die cutting, what are generally called strains such as plastic strains or elastic strains may be left at an end part of the core member or around the caulked part in the case of caulking lamination. Hence, for the purpose of eliminating these strains, straightening annealing of heating the motor core to a temperature on the order of 700° C. to 800° C. in a non-oxidizing atmosphere gas such as nitrogen gas, argon gas, carbon monoxide generated by incomplete combustion of butane gas or the like, followed by gradual cooling, has conventionally been conducted. This gradual cooling is carried out for avoiding generation of strains in the motor core at the time of cooling for improving iron loss and for preventing the dimensional accuracy from worsening. For example, a gradual cooling chamber for gradual cooling includes all or some of a stirring fan, an air-cooled pipe, a heater, and the like. For gradual cooling, a cooling rate on the order of 25° C./hour is recommended.

Meanwhile, since oil is used at the time of die cutting, or press forming, of the motor core and the oil is thereafter deposited on the surface of the motor core, it is desired to perform degreasing prior to annealing. In order to remove the oil component thus deposited on the surface of the object to be heat treated which is a target of annealing, proposals have been made to use a chemical agent, to realize a vacuum state, or to perform heating, and, for example, operating a vacuum device or operating a heating device has been put into practice (see, for example, the PATENT DOCUMENT 1).

### PATENT DOCUMENTS

### Patent Document 1

Japanese Patent Laid-open No. Hei 6-306490

### Patent Document 2

Japanese Patent Laid-open No. 2014-74566

### Patent Document 3

Japanese Patent Laid-open No. 2017-166721

### SUMMARY

### Technical Problem

The present inventors, as a result of their extensive and intensive studies, have found out a configuration by which degreasing to remove an oil component deposited on the surface of a motor core in the process of die cutting or the like can be performed and thereafter annealing can be performed in succession, without special use of a heating device or a vacuum device. It is an object of the present disclosure to provide a configuration by which degreasing of a motor core can be performed prior to straightening annealing without a heating device or a vacuum device dedicated to degreasing being provided.

### Solution to Problem

In accordance with one aspect of the present disclosure, there is provided a heat treatment furnace including a degreasing chamber for degreasing a motor core, a heating chamber with which the degreasing chamber directly communicates and which is configured to anneal the motor core that has passed through the degreasing chamber, by using a converted gas generated by a converted gas generation device, as an in-furnace atmosphere gas, and a gas flow formation section configured in such a manner that the converted gas in the heating chamber flows toward the degreasing chamber.

According to the heat treatment furnace configured as described above, the converted gas in the heating chamber flows into the degreasing chamber, and the motor core as the object to be heat treated in the degreasing chamber can be heated by the heat of the converted gas. Thus, degreasing of the motor core can be performed in the degreasing chamber prior to straightening annealing without a heating device or a vacuum device dedicated to degreasing being provided.

Preferably, the gas flow formation section includes a partition wall that partitions at least one half of the degreasing chamber into upper and lower parts, the partition wall being configured in such a manner that a lower space on a lower side of the partition wall directly communicates with the heating chamber and an upper space on an upper side of the partition wall communicates with the heating chamber by way of the lower space, an air introduction member that introduces air into the upper space, and a gas outlet provided in the upper space. This configuration makes it possible to prompt the converted gas to flow from the heating chamber toward the upper space side through the lower space, and to cause further combustion of the converted gas in the upper space.

Preferably, each of a plurality of the air introduction members is provided to extend in a conveying direction of the motor core and to extend toward the upper space by way of that space in the partition wall which connects the upper space and the lower space. This configuration makes it possible to cause further combustion of the converted gas in the upper space in a more suitable manner.

Preferably, a flame curtain formation device is further provided at an upstream end of the degreasing chamber. This configuration makes it possible to further assist the flow of the converted gas from the lower space into the upper space.

Preferably, the degreasing chamber further includes a heat exchanger through which the converted gas generated by the converted gas generation device flows before flowing into the heating chamber. This configuration makes it possible to transmit the heat of the converted gas generated by the converted gas generation device to the gas in the degreasing chamber.

Preferably, a blower that is located on the upstream side of the degreasing chamber in the conveying direction of the motor core and that sends wind toward the motor core is further provided. This configuration makes it possible to further prompt the degreasing of the motor core by the blower. It is recommendable that the blower be provided to generate warm airflow by use of dissipated heat on the heat treatment furnace side in air blowing. This is advantageous in terms of energy saving and also makes it possible to further prompt degreasing.

Preferably, the above-described heat treatment furnace further includes a cooling chamber with which the heating chamber directly communicates and which is configured to cool the motor core that has passed through the heating chamber, by using the converted gas as an in-furnace atmosphere gas. This configuration makes it possible to more suitably cool the motor core that has passed through the heating chamber.

### Advantageous Effect of Present Disclosure

According to the above-described aspect of the present disclosure, there is provided the heat treatment furnace configured as described above, whereby degreasing of the motor core can be performed prior to straightening annealing without a heating device or a vacuum device dedicated to degreasing being provided.

### BRIEF DESCRIPTION OF DRAWINGS

FIG. 1 is a schematic configuration view depicting a configuration of a heat treatment furnace according to a first embodiment of the present disclosure.

FIG. 2 is a sectional view in a conveying direction of a heating chamber of the heat treatment furnace of FIG. 1.

FIG. 3 is a sectional view taken along line III-III of FIG. 2.

FIG. 4 is a sectional view taken along line IV-IV of FIG. 2.

FIG. 5 is a graph depicting a relation between a mixing ratio of air and a fuel gas, and component ratios of a converted gas generated upon combustion thereof.

FIG. 6 is a sectional schematic view of a pre-chamber in the heat treatment furnace of FIG. 1.

FIG. 7 is a view, as viewed from an upstream side, of a hood of the pre-chamber in the heat treatment furnace of FIG. 1.

FIG. 8 is a flow chart depicting the flow of a treatment of an object to be heat treated in the heat treatment furnace of FIG. 1.

FIG. 9 is a sectional schematic view depicting a configuration of a part of a heat treatment furnace according to a second embodiment of the present disclosure.

### DESCRIPTION OF EMBODIMENTS

Embodiments of the present disclosure will be described below in reference to the attached drawings. The same parts (or configurations) are denoted by the same reference signs, and the names and functions of them are also the same. Hence, detailed description of them will not be repeated.

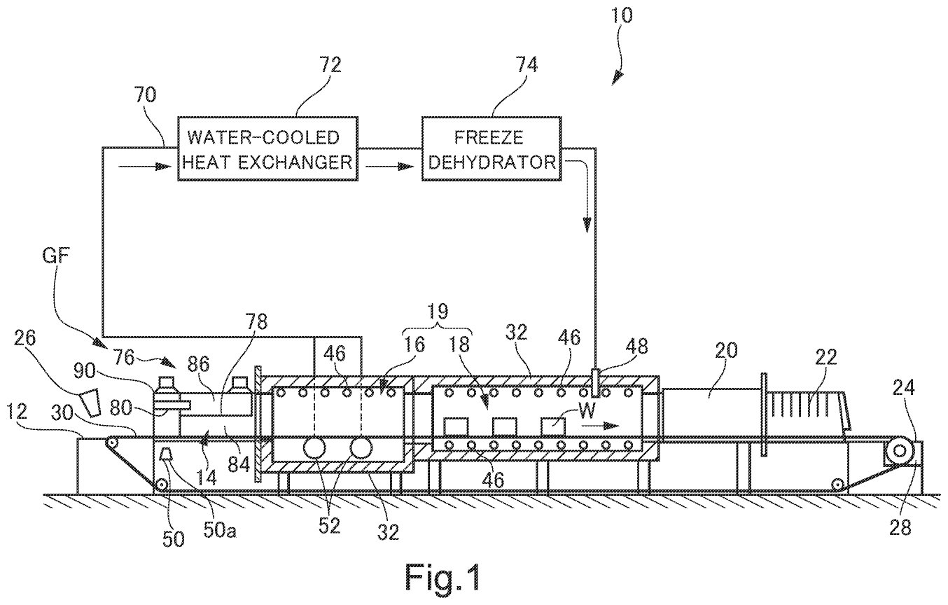

FIG. 1 depicts a schematic configuration of a heat treatment furnace 10 according to a first embodiment of the present disclosure. The heat treatment furnace 10 includes a conveying-in table 12, a pre-chamber 14 which is a degreasing chamber, a first heating chamber 16, a second heating chamber 18, a cooling chamber 20, a post-chamber (outlet chamber) 22, a conveying-out table 24, and the like in series in a direction in which an object to be heat treated W being a motor core is conveyed by conveying means (hereinafter the “conveying direction” or “longitudinal direction”) . The conveying-in table 12 is located on an upstream side of the pre-chamber 14 in a conveying direction of the object to be heat treated W, and a blower 26 for blowing air toward the object to be heat treated W on the conveying-in table 12 is provided. Note that a heating chamber 19 includes the first heating chamber 16 and the second heating chamber 18, and the heating chambers 16 and 18 may further be integrally united together.

The heat treatment furnace 10 includes a mesh belt conveyor 30 driven by a motor 28, as conveying means for conveying the object to be heat treated W in the conveying direction through the heat treatment furnace 10. Note that the conveying means is not limited to the mesh belt conveyor 30, and may be configured to have any of various known configurations.

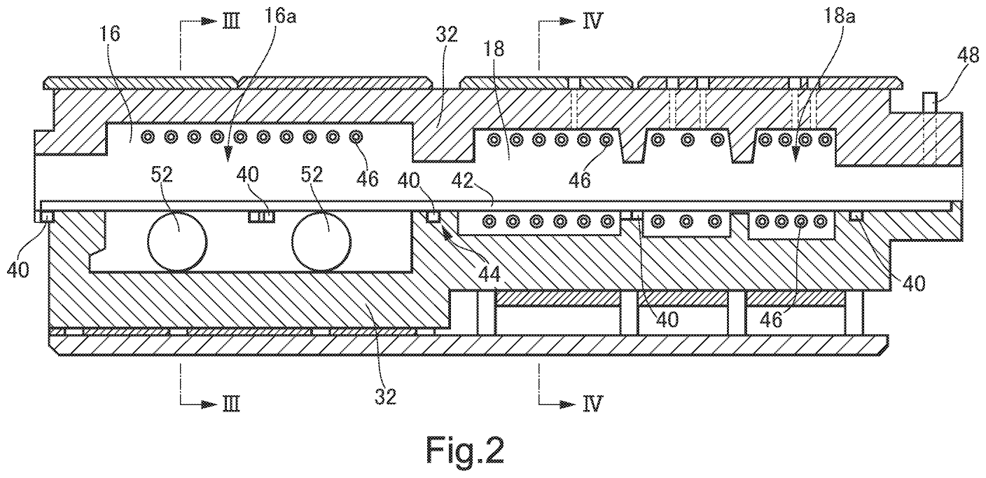

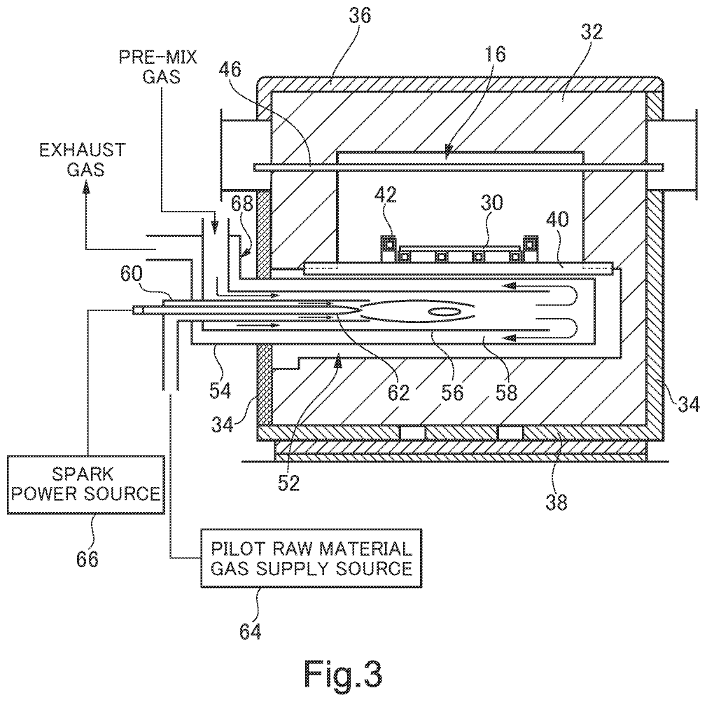

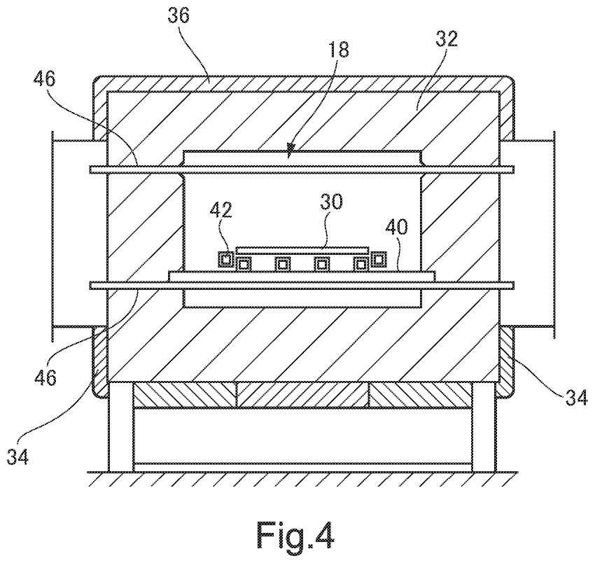

The first heating chamber 16 and the second heating chamber 18 are provided to directly communicate with each other as depicted in FIG. 2 and are rectangular in section orthogonal to the conveying direction as depicted respectively in FIGS. 3 and 4, and their peripheries are surrounded by heat-insulating walls 32 formed of ceramic fibers. As depicted in FIGS. 3 and 4, the heat-insulating walls 32 are formed in the state of being adhered to inside surfaces of both side outer walls 34 and upper and lower external walls 36 and 38 of the heat treatment furnace 1. Note that the heat-insulating walls 32 are not limited to being formed of the ceramic fibers, and may be configured by heat-resistant bricks, for example.

As depicted in FIGS. 2 to 4, in the first heating chamber 16 and the second heating chamber 18, a plurality of transverse beam members 40 extending in a direction (widthwise direction) orthogonal to the conveying direction are arranged on the lower heat-insulating wall 32 between the side outer walls 34. Further, a plurality of longitudinal beam members 42 extending in the conveying direction through the first heating chamber 16 and the second heating chamber 18 are disposed on the transverse beam members 40. The transverse beam members 40 and the longitudinal beam members 42 are disposed to intersect each other and form a support structure 44. The support structure 44 in which the transverse beam members 40 and the longitudinal beam members 42 are disposed to intersect each other supports, from the lower side, the mesh belt conveyor 30 which travels with the object to be heat treated W being the motor core mounted thereon.

As depicted in FIGS. 1 to 4, in the first heating chamber 16 and the second heating chamber 18, a plurality of heaters 46 extending in the widthwise direction below the upper heat-insulating wall 32 are disposed at intervals in the conveying direction. Further, in the second heating chamber 18, as depicted in FIGS. 1, 2, and 4, a plurality of heaters 46 extending in the widthwise direction are disposed above the lower heat-insulating wall 32 but below the longitudinal beam members 42 at intervals in the conveying direction. The object to be heat treated W is heated by the heaters 46, whereby a predetermined heat treatment is performed.

A converted gas introduction port 48 to be described later is singly provided for the second heating chamber 18 of the heating chamber 19 in FIG. 1, but may be provided in plural number rather than one, and, further, may be provided not only for the second heating chamber 18 but also for the first heating chamber 16, the cooling chamber 20, and the like. Here, the introduction port 48 is provided near a downstream end of the second heating chamber 18. The converted gas in the heating chamber 19 is prompted by a gas flow formation section GF described later to flow toward the pre-chamber 14 which is the degreasing chamber, whereby the converted gas supplied into the second heating chamber 18 is supplied to flow actively upstream from the second heating chamber 18 into the first heating chamber 16 and further into the pre-chamber 14. In addition, since the introduction port 48 is provided near the downstream end of the second heating chamber 18, the converted gas can sufficiently be supplied also into the cooling chamber 20 adjacent to the second heating chamber 18.

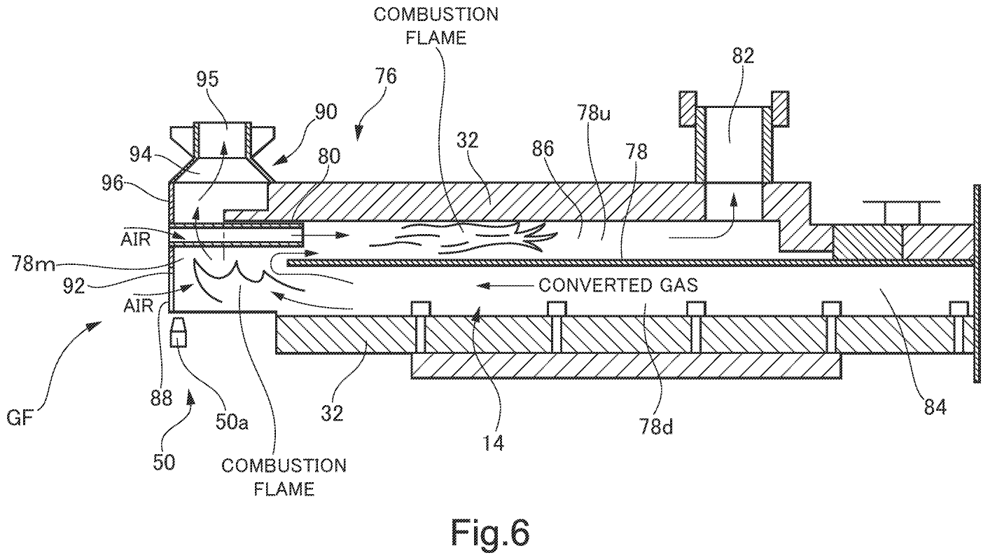

Note that a flame curtain formation device 50 is provided at an upstream end of the pre-chamber 14 which is the degreasing chamber. The flame curtain formation device 50 (see FIGS. 1 and 6) as a kind of curtain formation device is provided to restrain inflow of atmospheric air from the upstream side of the pre-chamber 14 into the heating chamber 19 including the first heating chamber 16 and the second heating chamber 18 and the pre-chamber 14, which communicates with the cooling chamber 20 by way of the heating chamber 19 to constitute together with them a tunnel, or the inside of the furnace, through which the object to be heat treated W is conveyed. The flame curtain formation device 50 includes a burner device 50a. The burner device 50a is located at the upstream end of the pre-chamber 14, specifically, at a lower part of the upstream-side inlet of the pre-chamber 14, and generates a flame from a lower side to an upper side of the mesh belt conveyor 30, whereby a curtain by a frame, that is, a flame curtain, is formed. Note that the flame curtain formation device 50 is not limited to this configuration, and may have another configuration. In addition, for example, the curtain formation device is not limited to the configuration of forming a curtain of a combustion gas, that is, a flame curtain, as the flame curtain formation device 50, and may be configured to form a gaseous curtain by at least partly using an inert gas and/or a nitrogen gas, for example.

Meanwhile, in the first heating chamber 16, there is provided a gas burner 52 for forming a converted gas. The gas burner 52 has roughly the same configuration as the configuration already proposed by the present inventors (see the PATENT DOCUMENT 2 and the PATENT DOCUMENT 3), and, hence, only its outline will be described here in reference to FIGS. 1, 2, and 3. Note that the gas burner 52 is one example of an atmosphere gas generation device, particularly, a converted gas generation device here.

The gas burner 52 is disposed under the mesh belt conveyor 30 in the first heating chamber 16, and includes a burner main body 54 including a radiant tube, a supply tube section 56, an exhaust gas passage section 58 formed around the supply tube section 56, a raw material gas supply tube section 6, and a spark rod 62 provided inside the raw material gas supply tube section 60.

A pilot raw material gas for combustion is supplied from a pilot raw material gas supply source 64 into the burner main body 54 by way of the raw material gas supply tube section 60, and a pre-mix gas obtained by premixing air and a raw material gas (that is, a fuel gas) is taken in from the supply tube section 56 and is supplied into the burner main body 54. Butane, propane, or the like is used as the raw material gas.

Further, the pilot raw material gas is combusted in the burner main body 54 by being ignited by application of a voltage to the spark rod 62, which is ignition means, by a spark power source 66. After combustion by ignition, the combustion is maintained by the pre-mix gas.

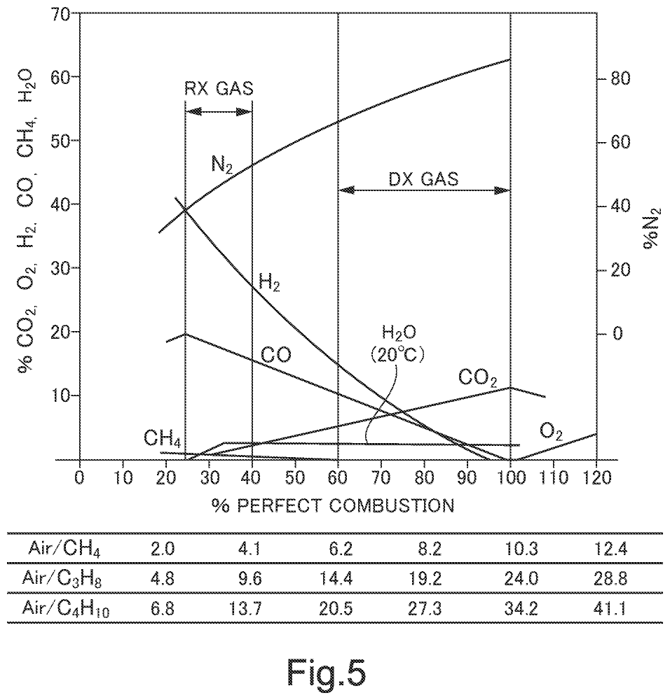

The object to be heat treated W conveyed into the first heating chamber 16 is heated by the heat of combustion produced by the gas burner 52. The converted gas generated by the combustion passes through the exhaust gas passage section 58, preheats the taken-in pre-mix gas in a preheating section 68, and is discharged from the gas burner 52. The converted gas thus generated is, for example, a DX gas which is an exothermic converted gas, and contains CO, CO₂, H₂, H₂O, and N₂ (see FIG. 5).

The converted gas discharged from the gas burner 52 is passed through a converted gas supply channel 70, to be supplied through the introduction port 48 into the heating chamber 18, as depicted in FIG. 1. A water-cooled heat exchanger 72 and a freeze dehydrator 74 are sequentially disposed in the converted gas supply channel 70.

The converted gas is cooled to a temperature on the order of 40° C. by the water-cooled heat exchanger 72 in the process of passing through the converted gas supply channel 70, is cooled to a temperature on the order of 5° C. and dehydrated in the freeze dehydrator 74, and is sent into the second heating chamber 18.

Note that the first heating chamber 16, the second heating chamber 18, and the cooling chamber 20 are arranged in this order in the conveying direction, and communicate with one another. Hence, the freeze dehydrator 74 is connected also to the cooling chamber 20 in addition to the second heating chamber 18, and may supply the converted gas cooled and dehydrated as described above from the freeze dehydrator 74 to directly distribute the converted gas into the second heating chamber 18 and the cooling chamber 20.

Note that the apparatuses disposed in the converted gas supply channel 70 are not limited to the water-cooled heat exchanger 72 and the freeze dehydrator 74, and apparatuses corresponding to a desired heat treatment may be disposed. For example, a CO₂ adsorption device may be provided in place of, or in addition to, either one of or both the water-cooled heat exchanger 72 and the freeze dehydrator 74.

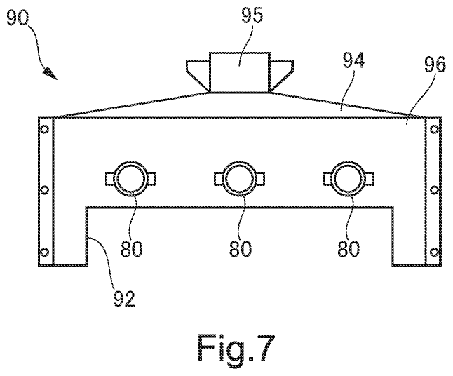

Meanwhile, the pre-chamber 14 communicating with the upstream side of the heating chamber 19 including the first and second heating chambers 16 and 18 includes a converted gas combustion device 76. The gas flow formation section GF includes the converted gas combustion device 76. The gas flow formation section GF is configured in such a manner that the converted gas in the heating chamber 19 flows toward the pre-chamber 14 which is the degreasing chamber. As depicted in FIGS. 6 and 7, the converted gas combustion device 76 includes a partition wall 78, an air introduction pipe 80, and an exhaust gas outlet 82. A specific configuration of the pre-chamber 14 including the converted gas combustion device 76 will be described below.

As depicted in FIG. 6, the pre-chamber 14 has its interior partitioned into upper and lower parts by a substantially horizontal partition wall 78 extending in the conveying direction. The partition wall 78 partitions at least one half of the pre-chamber 14, here at least one half of the pre-chamber 14 on the downstream side in the conveying direction, more specifically at least 70% of the pre-chamber 14 on the downstream side in the conveying direction, into upper and lower parts. With the partition wall 78 thus provided, the pre-chamber 14 is substantially partitioned into a space (upper space) 78u on the upper side of the partition wall 78 and a space (lower space) 78d on the lower side of the partition wall 78. The lower space 78d directly communicates with the first heating chamber 16 of the heating chamber 19, whereas the upper space 78u communicates with the heating chamber 19 by way of the lower space 78d. The lower side of the partition wall 78, that is, the lower space 78d, is a conveying-in chamber 84 in which the mesh belt conveyor 30 not depicted in FIG. 6 is disposed, and which directly communicates with the first heating chamber 16.

The upper space 78u on the upper side of the partition wall 78 is a converted gas combustion chamber 86 surrounded by the heat-insulating walls 32 formed of ceramic fibers. The tip side (the right end side in FIG. 6) of the converted gas combustion chamber 86 in the conveying direction is closed, and is provided with the exhaust gas outlet 82 directed upward. The exhaust gas generated by combustion in the converted gas combustion chamber 86 is exhausted through the exhaust gas outlet 82.

The base end section, or the upstream-side end section, of the pre-chamber 14 in the conveying direction is a conveying-in port 88 for the object to be heat treated W, and a hood 90 as depicted in FIGS. 6 and 7 is attached to the base end section, or the upstream-side end section, thereof. The hood 90 is attached to the upper side of the upstream-side end section of the pre-chamber 14 from the upstream side in the conveying direction. An opening (opening section) 92 for conveying the object to be heat treated W into the pre-chamber 14 is provided in a lower part of the hood 90, and an exhaust gas section 94 is formed at an upper part thereof. When the hood 90 is attached, the opening section 92 partitions and forms a part of the conveying-in port 88, the opening section 92 of the hood 90 is located exactly on the upstream side of the lower space 78d in the conveying direction, and the exhaust gas section 94 of the hood 90 is located exactly on the upstream side of the upper space 78u in the conveying direction.

On the upper side of the exhaust gas section 94, an exhaust gas outlet 95 is provided in the state of being directed upward. In addition, one or a plurality of, here three, air introduction pipes 80 are attached to a front wall of the hood 90 in the state of being directed toward the inside of the converted gas combustion chamber 86. The air introduction pipes 80 are air introduction members for introducing air into the upper space 78u. Each of the plurality of air introduction pipes 80 is provided in such a manner as to extend in the conveying direction of the object to be heat treated W which is the motor core, and extends toward the upper space 78u by passing through that space 78m in the partition wall 78 which connects the upper space 78u and the lower space 78d. As depicted in FIG. 6, the tip part (an end part on the right side in FIG. 6) of each air introduction pipe 80 extends to the downstream side of the upstream-side end section of the partition wall 78 in the conveying direction in the heat treatment furnace 10. However, the tip part of the air introduction pipe 80 may be designed to terminate at, or before reaching, the same position as the upstream-side end section of the partition wall 78 in the conveying direction in the heat treatment furnace 10. It is recommendable that the extending length of the tip part of the air introduction pipe 80 be set in such a manner as to smoothen the flow of the converted gas from the lower side to the upper side of the partition wall 78.

Since the gas flow formation section GF includes the converted gas combustion device 76 of the above-described configuration, the converted gas used as the in-furnace atmosphere gas in the heat treatment furnace 10, particularly, in the second heating chamber 18 and the first heating chamber 16, is pulled toward the converted gas combustion chamber 86 side in the lower space 78d, and flows from the downstream side toward the upstream side in the conveying direction. Then, the converted gas flows from the base end side, that is, the upstream side, of the conveying-in chamber 84 of the pre-chamber 14 which is the degreasing chamber into the converted gas combustion chamber 86 in the upper space 78u, and reacts with air introduced from the air introduction pipes 80 in the converted gas combustion device 76, whereby the converted gas can be combusted in the converted gas combustion chamber 86. The combusted gas, that is, the exhaust gas, is exhausted mainly through the exhaust gas outlet 82. The exhaust gas may be exhausted through the exhaust gas outlet 95.

Note that, it is recommendable that a cleaning device for a cleaning treatment of the exhaust gas, for example, a catalyst device, be disposed at the exhaust gas outlet 82 and the exhaust gas outlet 95.

Further, the above-described burner device 50a is provided on the lower side of the opening 92 on the lower side of the hood 90. Thus, by the flame curtain formed by the burner device 50a of the flame curtain formation device 50, the converted gas flowing from the downstream side to the upstream side toward the pre-chamber 14 in the conveying direction is prevented from being discharged directly through the inlet of the heat treatment furnace 10, and the flow of the converted gas from the downstream side is prompted accessorily.

The above-described blower 26 for sending wind toward the object to be heat treated W being the motor core located on the upstream side of the pre-chamber 14 which is the degreasing chamber in the conveying direction is further provided. The blower 26 is provided in the state of being supported by unillustrated support means on the conveying-in table 12 which is open without constituting a tunnel as the pre-chamber 14, the first heating chamber 16, and the second heating chamber 18. The air blowing by the blower 26 may be conducted with airflow of a normal temperature or may be conducted with heated air, that is, hot air, but, here, is conducted with airflow of the normal temperature. Note that, in terms of a degreasing effect for the motor core, it is recommendable that the blower 26 include a heater and a fan to send hot airflow, but, here, the blower 26 does not include a heater to send normal-temperature airflow from the viewpoint of energy saving. In this instance, it is further recommendable that, with an expectation for an accessory degreasing effect and from the viewpoint of energy saving, the blower 26 be provided to generate warm airflow with use of dissipated heat on the heat treatment furnace 10 side in air blowing. This can be realized, for example, by providing the blower 26 in such a manner as to send airflow toward the upstream side on the outside of the conveying-in port 88 for the object to be heat treated W. As described above, the blower 26 is not limited to being provided on the conveying-in table 12 itself, and may be provided at other places. In addition, it may be recommendable, for example, to provide a heat exchanger in the surroundings of the gas burner 52, for example, in the exhaust gas passage section 58, at the outlet section of the heating chamber 19 of the heat treatment furnace 10, or at the upstream end of the cooling chamber 20, and to use, by the blower 26, the heat taken out at the heat exchanger. The blower 26 is not limited to having such a configuration, and may have any of various configurations. For example, the blower 26 may be provided as one body with the heat treatment furnace 10, or may be provided detachably or movably at the heat treatment furnace 10, and can have any of various configurations of being disposed in such a manner as to prompt degreasing of the motor core on the upstream side of the pre-chamber 14.

The cooling chamber 20 includes unillustrated cooling means, for example, a cooling system, to cool the object to be heat treated W that has passed through the second heating chamber 18, at a predetermined cooling rate.

Note that the heat treatment furnace 10 configured as described above may be modified variously, and, for example, may be modified as follows. A partition door is not provided between the first heating chamber 16 and the second heating chamber 18, but may be provided there. Similarly, a partition door is not provided also between the second heating chamber 18 and the cooling chamber 20, but may be provided there.

Each of the heaters 46 provided respectively in the first heating chamber 16 and the second heating chamber 18 of the heating chamber 19 as described above is controlled such that the temperature in the chamber in which it is set becomes a corresponding target temperature. A controller is provided to control the operation of each of the heater 46 and/or the gas burner 52, for example, and it is recommendable that control be conducted such that the in-furnace temperature, the in-furnace atmosphere gas, and the like is in desired states.

For control of the controller, various sensors can be provided in the heat treatment furnace 10. It is recommendable that an oxygen sensor capable of measuring oxygen partial pressure be provided, but other various sensors such as a temperature sensor for measuring temperature can be provided. For example, a hydrogen sensor for measuring hydrogen partial pressure, a dew point sensor for measuring the dew point in the heat treatment furnace 10, a CO sensor capable of measuring carbon monoxide partial pressure, a CO₂ sensor capable of measuring carbon dioxide partial pressure, and the like may be provided. In this case, the controller including a processor (for example, a CPU) and memories (for example, a ROM and a RAM) receives outputs or output signals from the above-mentioned various sensors such as the temperature sensor as inputs, and, according to the inputs from the various sensors, the controller executes arithmetic processing according to a predetermined program, to thereby output operation signals to the heater 46 and/or the gas burner 52 and the like.

In the heat treatment furnace 10, the object to be heat treated W is conveyed to be mounted on the conveying-in table 12, to be exposed to the wind from the blower 26, to enter the opening 92 which is an entrance, to pass sequentially through the pre-chamber 14, the first heating chamber 16, the second heating chamber 18, and the cooling chamber 20, and to go out through an exit of the post-chamber 22, to reach the conveying-out table 24. In the heat treatment furnace 10, the cooling chamber 20 is directly connected to the downstream side of the heating chamber 18, without a gradual cooling chamber therebetween. Thus, the object to be heat treated W coming out of the heating chamber 19 including the first heating chamber 16 and the second heating chamber 18 is immediately cooled in the cooling chamber 200. Note that, in a conventional heat treatment furnace for general annealing of a motor core, a gradual cooling chamber is provided on the downstream side of the heating chamber 18 and on the upstream side of the cooling chamber 20 to gradually cool the object to be heat treated W, and the heat treatment furnace 10 can also be provided with a gradual cooling chamber.

Note that it is recommendable that the length of the cooling chamber 20 in the longitudinal direction, or the conveying direction, be designed according to the target cooling rate of the object to be heat treated W in the cooling chamber 20. In addition, the cooling chamber 20 may be divided into a plurality of cooling sections, and the cooling sections may be mutually connected in the conveying direction to constitute the cooling chamber 20.

In the heat treatment furnace 10, an exit is provided at the downstream end of the cooling chamber 20. In other words, the cooling chamber 20 is connected to the exit of the heat treatment furnace 10 without a bluing treatment chamber therebetween. In other words, the heat treatment furnace 10 according to one embodiment of the present disclosure is not one in which a bluing treatment is conducted successively after straightening annealing. However, providing a bluing treatment chamber on the downstream side of the cooling chamber 20 is not excluded. In other words, a bluing treatment chamber may be provided on the downstream side of the cooling chamber 20. The bluing treatment is a treatment in which a high dew point gas such as water vapor is blown at the time of temperature fall of an annealing furnace, to form an oxide film on a surface of a steel sheet. More specifically, the bluing treatment is a treatment in which a high dew point gas is blown into a treatment chamber at 350° C. to 550° C. to form an oxide coating film such as iron oxide (II) (FeO) or triiron tetraoxide (Fe₃O₄) on the surface of an object to be heat treated. Note that the bluing treatment is carried out with the purpose of enhancing corrosion resistance or rustproof property of a die-cut end face, for example. It is to be noted, however, that, using a DX gas containing water as an in-furnace atmosphere gas in the heating chamber 18 up to the cooling chamber 20 allows an effect equivalent to that obtained when the bluing treatment is conducted to be obtained without the bluing treatment being performed, but the description of the details thereof is omitted here.

Here, the object to be heat treated W will be described. A starting material of the object to be heat treated is an electrical steel sheet, and, in a more specific example, a non-oriented electrical steel sheet used for an iron core of a motor (motor core) and the like. The starting material may be an oriented electrical steel sheet used for an iron core of a transformer and the like. The electrical steel sheet is a soft magnetic material, and is demanded to be excellent in magnetic properties, particularly, to be low in iron loss.

The non-oriented electrical steel sheet is typically produced by primary recrystallization and crystal grain growth treatment by continuous annealing after a series of pig iron making, steel making, hot rolling, and cold rolling. The non-oriented electrical steel sheet thus produced is subjected to predetermined die cutting, and, for example, a plurality of sheets are stacked in the die, to form a laminate material. The electrical steel sheets are laminated by such a method as welding, adhesion, and/or caulking. As a result, a motor core with low iron loss as the object to be heat treated which is to be subjected to straightening annealing in the heat treatment furnace 10 can be obtained. However, the object to be heat treated is not limited to the one produced by this method. In addition, as will be described later, the motor core to be heat treated is not limited to the laminated one, and may be one which is not laminated.

Note that the composition of the electrical steel sheet to be heat treated in the heat treatment furnace according to the present disclosure and/or to be served to the heat treatment method according to the present disclosure is not particularly limited to any kind. For example, a steel sheet defined by JIS C2552, a steel sheet defined by JIS C2553, a steel sheet defined by JIS C2555, and the like can be used preferably. In addition, the thickness of the electrical steel sheet to be used is not particularly limited to any thickness.

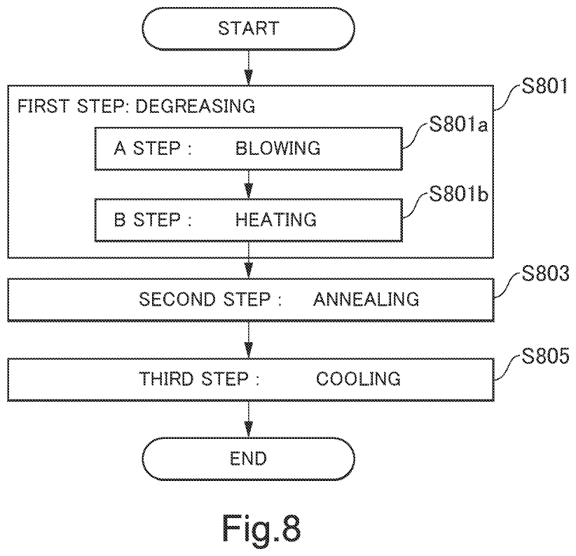

Meanwhile, a heat treatment method for the object to be heat treated in the heat treatment furnace 10 will be described in reference to FIG. 8. FIG. 8 is a flow chart of one example of the heat treatment method according to the present embodiment.

As depicted in FIG. 8, the heat treatment method according to the present embodiment includes a first step (step S801) of degreasing the motor core as the object to be heat treated, a second step (step S803) of annealing the motor core having undergone the first step, by using a converted gas as an in-furnace atmosphere gas, and a third step (step S805) of cooling the motor core obtained in the second step, at a predetermined cooling rate by using the converted gas as the in-furnace atmosphere gas.

The first step (step S801) is a step of carrying out degreasing of the motor core, that is, the object to be heat treated W, and is called the degreasing step. The first step includes a degreasing step by blowing air, that is, an A step (step S801a), and a degreasing step by heating, that is, a B step (step S801b).

In the A step (step S801a), degreasing is prompted by sending wind toward the object to be heat treated W by the blower 26. This air blowing may be conducted with normal-temperature airflow, or may be conducted with heated airflow, that is, hot airflow; here, the air blowing is conducted with the normal-temperature airflow. Since oil to be used in the die cutting step of the motor core, that is, at the time of press forming, is typically one which is good in volatility, a sufficient degreasing effect can be expected even with normal-temperature airflow. For example, the oil deposited on the surface of the motor core is substantially evaporated in 2 to 3 hours when left to stand at a temperature of, for example, 25° C. Besides, since the blower 26 is provided in the state of being supported by unillustrated support means on the conveying-in table 12 which is open without constituting a tunnel as the pre-chamber 14, the first heating chamber 16, and the second heating chamber 18, the oil component deposited on the surface of the object to be heat treated W can be spontaneously evaporated by air blowing by the blower 26, thereby prompting degreasing.

The B step (step S801b) is a step in which the laminated motor core, that is, the object to be heat treated W, is heated in the pre-chamber 14 at a temperature in a predetermined temperature zone (hereinafter, the predetermined first temperature zone), thereby prompting degreasing. The first step including the B step is conducted with a main purpose of removing an oil component such as press forming oil deposited on the motor core which is the object to be heat treated W. Note that the first step may include only the B step, without the above-described A step being provided. In addition, the first step may include a further degreasing step other than the B step or both the A step and the B step. Note that the first temperature zone is a temperature range that does not affect the characteristic properties of the object to be heat treated W, and is set to be, for example, not more than 500° C. The converted gas combustion device 76 of the gas flow formation section is designed to bring the lower space 78d of the pre-chamber 14 to such a temperature. It is recommendable that the first temperature zone be set to be, for example, not less than 100° C., preferably not less than 200° C.

The second step (step S803) is a step of annealing (heat treating) the laminated motor core in the heating chamber 19. In molding conducted by die cutting or caulking, for example, local strain in the iron core stemming from plastic strain or residual stress is generated. Thus, in order to eliminate the strain, an annealing treatment is conducted in the second step. In the second step, the motor core is heated for a predetermined period of time at a temperature of straightening annealing of the motor core, preferably, at a soaking temperature. A temperature rise to the soaking temperature is mainly conducted in the first heating chamber 16, and a soaking treatment is substantially conducted in the second heating chamber 18. The annealing conditions are not particularly limited to any kind; normally, the motor core is kept at a temperature on the order of 750° C. to 850° C. for a time on the order of 30 minutes to 2 hours. Thus, the temperature zone in the second step (hereinafter, the predetermined second temperature zone) is higher than the above-described first temperature zone. Note that, here, in the third step described next, the motor core is not gradually cooled but cooled at a cooling rate in excess of, for example, 300° C./hour; hence, the heat treatment in the second step will be called annealing or an annealing treatment, and the second step will be called the annealing step.

The third step (step S805) is a step in which the motor core having undergone the annealing treatment in the second step is cooled in the cooling chamber 20 at a predetermined cooling rate which does not mean quenching, here, a cooling rate in excess of 300° C./hour. The third step is called a cooling step here. Since the cooling chamber 200 is provided on the downstream side of the heating chamber 19 in the state of directly communicating with the heating chamber 19, the third step (cooling step) is conducted immediately after the second step (annealing step).

It is recommendable that the cooling rate in the third step be a rate in excess of 300° C./hour (that is, 300° C./hour<the cooling rate). By setting the cooling rate to a value to be in excess of 300° C./hour, the length of time required for the treatment can be shortened. In addition, it is recommendable that, for setting the cooling rate to a value in excess of 300° C./hour, not only simply cooling means but also forced cooling equipment (for example, a forced cooling fan) be provided additionally. Note that the cooling rate may be, for example, a cooling rate of not more than 700° C./hour, a cooling rate of not more than 600° C./hour, or a cooling rate of not more than 500° C./hour. Note that the present disclosure does not exclude performance of gradual cooling, for example, at a cooling rate on the order of 25° C./hour, or at a cooling rate between 25° C./hour and 300° C./hour, in a part or the whole of the third step.

The cooling of the motor core at the cooling rate in the cooling chamber 20 in the third step is carried out at least in a temperature zone from the temperature in the second step (annealing step), preferably, the soaking temperature (for example, 850° C.), to 500° C. It is to be noted, however, that the above-mentioned cooling rate is an average cooling rate in such a temperature zone. Note that the cooling of the motor core at the cooling rate in excess of 300° C./hour may be conducted in the temperature zone from the temperature in the second step to 300° C.

Note that as described above, the heat treatment method according to the present embodiment does not exclude further performance of a bluing treatment other than the above-described steps (see FIG. 8). In other words, a bluing treatment may be conducted after the third step. When the bluing treatment is not conducted after the third step, it is recommendable that the cooling of the motor core at the cooling rate in excess of 300° C./hour be conducted in the temperature zone from the temperature in the second step to 300° C. Note that these do not exclude cooling of the motor core at the cooling rate in the temperature zone from the temperature in the second step to 300° C., which is lower than 500° C., when the bluing treatment is conducted after the third step.

Further, in the degreasing in the B step of the first step, the annealing in the second step, and the cooling in the third step, an exothermic converted gas is used as the in-furnace atmosphere gas. Examples of the exothermic converted gas include the DX gas. Note that the converted gas used in the heat treatment furnace 10 is not limited to the DX gas, and does not exclude, for example, an endothermic converted gas (for example, RX gas).

It is to be noted, however, that at the time of cooling in the cooling chamber 20 in the third step, it is preferable that the oxygen partial pressure of the in-system cooling atmosphere in the cooling chamber 20 be set to a value of not less than a lower oxygen equilibrium partial pressure of the oxygen equilibrium partial pressure of 3/2Fe+O₂=1/2Fe₂O₃ and the oxygen equilibrium partial pressure of 2Fe+O₂=2FeO, and not more than the oxygen equilibrium partial pressure of 4/3Fe+O₂=2/3Fe₂O₃. This is for suitable control of oxidation of the motor core, and may be understood from the Ellingham diagram representing the standard free energy of formation of iron oxide. It is recommendable that the operation of the gas burner 52 as the converted gas generation device and the like be controlled in such a manner as to realize this atmosphere.

According to the heat treatment furnace 10 configured as described above, the pre-chamber 14 as the degreasing chamber includes the gas flow formation section GF configured as described above. As a result, the converted gas in the heating chamber 19 can flow from the downstream side toward the upstream side in the conveying direction, that is, toward the pre-chamber 14. The converted gas is the atmosphere gas used for annealing of the motor core, and thus is at a high temperature. Hence, by the passage of the object to be heat treated W which is the motor core through the pre-chamber 14, the degreasing thereof is performed. As described above, a heating device, that is, a heater or a vacuum device, for example, a vacuum pump, dedicated to degreasing is provided in the pre-chamber 14 which is the degreasing chamber. Accordingly, the heat treatment furnace 10 is very excellent in terms of energy saving.

In addition, since the pre-chamber 14 which is the degreasing chamber communicates with the heating chamber 19, the pre-chamber 14 can receive radiant heat from the heating chamber 19. As a result, the passage of the object to be heat treated W which is the motor core through the pre-chamber 14 effects further degreasing.

Further, since the pre-chamber 14 which is the degreasing chamber includes the gas flow formation section GF configured as described above, the converted gas reacts with air with the result of combustion in the converted gas combustion chamber 86 of the pre-chamber 14. The pre-chamber 14 is further heated by this combustion, whereby degreasing of the object to be heat treated W which is the motor core in the pre-chamber is further urged.

In addition, the converted gas from the combustion chamber 19 flows from the conveying-in chamber 84 corresponding to the lower space 78d on the lower side of the partition wall 78 in the pre-chamber 14 into the converted gas combustion chamber 86 corresponding to the upper space 78u, is preferably combusted, and is exhausted through the exhaust gas outlets 82 and 95. Thus, the oil or the like volatilized in the pre-chamber 14 does not stagnate in the pre-chamber 14, and can be prevented from flowing toward the combustion chamber 19 side. As a result, the necessity to provide a heating device or a vacuum device dedicated to degreasing is further eliminated.

Note that the blower 26 is provided on the upstream side of the pre-chamber 14, and the degreasing before annealing of the object to be heat treated W which is the motor core is further prompted by the airflow generated by the blower 26. It is widely known that the blower 26 typically needs less energy than a heater. It is obvious that, even if the blower 26 is adopted, the heat treatment furnace 10 is more excellent in energy saving as compared to the case where a heating device or a vacuum device dedicated to degreasing is provided to perform degreasing.

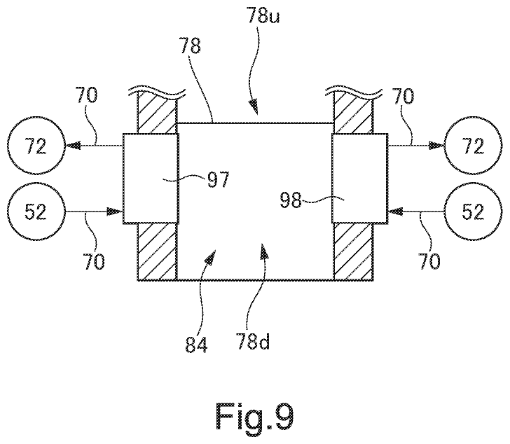

Next, a heat treatment furnace according to a second embodiment of the present disclosure will be described in reference to FIG. 9. The heat treatment furnace according to the second embodiment differs from the heat treatment furnace 10 of the first embodiment in that it has a configuration by which the heat of the converted gas discharged from the gas burner 52 can be utilized in the pre-chamber 14 as the degreasing chamber, but has the same configuration as the heat treatment furnace 10 in other points. In view of this, hereinafter, only the differences of the heat treatment furnace of the second embodiment from the heat treatment furnace 10 will be described, and other descriptions will be omitted.

The converted gas generated at the gas burner 52 has a temperature of, for example, near 900° C. In the heat treatment furnace 10 of the first embodiment, the gas is cooled through the water-cooled heat exchanger 72 and the freeze dehydrator 74 to remove moisture in the gas to a certain extent. In order to effectively utilize the waste heat in this instance, heat exchangers 97 and 98 are provided in a pre-chamber 6, as depicted in FIG. 9. FIG. 9 is a sectional view orthogonal to the conveying direction of a part of the pre-chamber 14. The heat exchangers 97 and 98 are provided at a wall section defining the lower space 78d of the pre-chamber 14. Since the heat treatment furnace of the second embodiment is also provided with two gas burners 52, it includes two heat exchangers 97 and 98, as depicted in FIG. 1. Here, the converted gas of the gas burner 52 on one side is supplied to the heat exchanger 97 on one side, and the converted gas of the gas burner 52 on the other side is supplied to the heat exchanger 98 on the other side. This however does not limit the number of the heat exchangers. In addition, the number of the gas burners and the number of the heat exchangers may be different from each other.

To the respective ones of the heat exchangers 97 and 98, converted gas supply channels 70 of the corresponding gas burners 52 are connected. The heat exchangers 97 and 98 are respectively provided between the gas burner 52 and the water-cooled heat exchanger 72 in the converted gas supply channels 70. Thus, the heat of the high-temperature converted gas is transmitted to the gas, or the converted gas, in the lower space 78d through the heat exchangers 97 and 98, to be used for heating of the converted gas, that is, for degreasing of the motor core.

As described above, according to the heat treatment furnace of the second embodiment, the heat exchangers 97 and 98 are provided, so that the heat of the converted gas before being cooled and dehydrated by the water-cooled heat exchanger 72 and the freeze dehydrator 74 can be used for heating the converted gas in the lower space 78d, that is, in the conveying-in chamber 84. Hence, the degreasing in the pre-chamber 14 can be prompted more suitably. Consequently, the heat treatment furnace of the second embodiment utilizes the waste heat of the converted gas more effectively, and is more excellent in energy saving as compared to the above-described heat treatment furnace 10.

Examples will be described below.

### Experiment Example 1

As samples of Examples, a plurality of motor cores prepared as described above were subjected to treatments in a heat treatment furnace which combines the configurations of the above-described first embodiment. This heat treatment furnace has the same configuration as that of the above-described heat treatment furnace 10 except for not including the blower 26. Specifically, each of the plurality of the motor cores prepared was degreased in the pre-chamber 14 being the degreasing chamber (the first step), was subsequently annealed in the heating chamber 19 (the second step), and was thereafter cooled in the cooling chamber 20 (the third step), to thereby perform a straightening annealing treatment. Note that the cooling for degreasing in the pre-chamber 14 in the first step was conducted at a temperature in a predetermined first temperature zone of 200° C. to 300° C., i.e., at approximately 250° C. here, for a first predetermined time, i.e., for approximately 10 minutes here. In addition, the heat treatment temperature in the second heating chamber 18 of the heating chamber 19 in the second step was a temperature in a predetermined second temperature zone higher than the predetermined first temperature zone, that is, 750° C. to 850° C., and the cooling rate in the third step was a cooling rate on the order of 350° C./hour in a temperature zone from the heat treatment temperature to 500° C. Besides, the DX gas which is the exothermic converted gas was used as an atmosphere gas. In this way, the motor cores of Examples 1 to 6 were obtained.

### Evaluation

In regard of the motor cores before and after the treatment in the heat treatment furnace, iron loss was evaluated as a characteristic property thereof.

With use of a stator core magnetic characteristics tester “DAC-LST-3” made by SOKEN ELECTRIC CO., LTD. as a measurement device for iron loss of the motor core, iron loss was measured at a flux density of 1 T and a measurement frequency of 300 Hz.

Table 1 sets forth the iron loss values (W/kg) of the motor cores of Examples 1 to 6.

TABLE 1

Iron loss value

| | | Before treatment | After treatment |
|---|---|---|---|
| Degreasing | Example 1 | 9.13 | 6.95 |
| performed | Example 2 | 8.90 | 6.96 |
| | Example 3 | 8.93 | 6.97 |
| | Example 4 | 8.95 | 6.90 |
| | Example 5 | 9.07 | 6.89 |
| | Example 6 | 8.99 | 6.91 |

As set forth in Table 1, in Examples in which the first step of degreasing was conducted before the second step of annealing, the iron loss value was reduced by the treatment in the heat treatment furnace 10, and a clear improvement was recognized. Note that this was similar to variation in iron loss value upon gradual cooling after annealing in the heating chamber 19.

### Experiment Example 2

In the heat treatment furnace of Experiment Example 1, the motor core as the object to be heat treated was immersed in oil, then the motor core was fed sequentially through the degreasing chamber and the heating chamber, and variation in the atmosphere gas by volatilization of the oil was examined. As the oil, “G-6339F” made by NIHON KOHSAKUYU CO., LTD. was used. This oil (G-6339F) is a very typical metal working lubricant, and is widely used particularly as press forming oil for motor cores. In this experiment, the operation of each heater 16 was controlled in such a manner that the first heating chamber 16 and the second heating chamber 18 were substantially brought to 800° C. In addition, the DX gas which is an exothermic converted gas was used as an atmosphere gas.

### Evaluation

In Experiment Example 2, a plurality of motor cores were used as specimens, and each of the motor cores was fed sequentially through the degreasing chamber and the heating chamber. An in-furnace atmosphere 16a (see FIG. 2) of the first heating chamber 16 and an in-furnace atmosphere 18a (see FIG. 2) of the second heating chamber 18 in this instance were collected, and CO₂ concentrations and CO concentrations of the atmospheres 16a and 18a were respectively measured by a CO₂ sensor and a CO sensor.

The measurement results of the CO₂ concentration (%) and the CO concentration (%) of the in-furnace atmosphere 16a of the first heating chamber 16 are set forth in Table 2. In addition, the measurement results of the CO₂ concentration (%) and the CO concentration (%) of the in-furnace atmosphere 18 a of the second heating chamber 18 are set forth in Table 3. In each of Tables 2 and 3, “before treatment” refers to a state before the treatment of the motor core which is the object to be heat treated, “during treatment” refers to a state when the motor core is there, that is, in the first heating chamber 16 or the second heating chamber 18, and “after treatment” refers to a state after the lapse of a predetermined period of time from passage of the motor core through the first heating chamber 16 or the second heating chamber 18. It is to be noted, however, that the average of the measured values “before treatment” is taken as 1.00, and, with this value as a reference, values corresponding to the respective measured values are set forth respectively in Tables 2 and 3.

TABLE 2

| | | Before | During | After |
|---|---|---|---|---|
| | | treatment | treatment | treatment |
| CO₂ | Average | 1.00 | 1.01 | 1.00 |
| | Max. | 1.01 | 1.01 | 1.02 |
| | Min. | 0.993 | 0.993 | 0.993 |
| CO | Average | 1.00 | 0.992 | 1.01 |
| | Max. | 1.01 | 1.00 | 1.03 |
| | Min. | 0.928 | 0.928 | 0.956 |

TABLE 3

| | | Before | During | After |
|---|---|---|---|---|
| | | treatment | treatment | treatment |
| CO₂ | Average | 1.00 | 1.00 | 1.00 |
| | Max. | 1.01 | 1.01 | 1.01 |
| | Min. | 0.993 | 0.994 | 0.996 |
| CO | Average | 1.00 | 1.01 | 1.01 |
| | Max. | 1.01 | 1.02 | 1.02 |
| | Min. | 0.989 | 0.990 | 0.997 |

As set forth in Tables 2 and 3, the CO₂ concentration and the CO concentration during and after the treatment are not much different from, and are substantially the same as, those before treatment. This perhaps indicates that a flow of the in-furnace atmosphere gas from the downstream side toward the upstream side is generated by the gas flow formation section GF, so that the in-furnace atmosphere gas can constantly be kept in a suitable state while volatilization of the oil is suitably caused.

While typical embodiments of the present disclosure and the like have been described above, the present disclosure is not limited to them, and various modifications are possible. Various replacements and modifications are possible insofar as they do not depart from the spirit and scope of the present disclosure which are defined by the claims of the present application.

1. A heat treatment furnace comprising:
a degreasing chamber for degreasing a motor core;
a converted gas generation device;
a heating chamber with which the degreasing chamber directly communicates and which is configured to anneal the motor core that has passed through the degreasing chamber, by a converted gas generated by the converted gas generation device, as an in-furnace atmosphere gas; and
a gas flow formation section configured such that the converted gas in the heating chamber flows toward the degreasing chamber.

2. The heat treatment furnace according to claim 1, wherein the gas flow formation section comprises:
a partition wall that partitions at least one half of the degreasing chamber into upper and lower parts, the partition wall being arranged such that a lower space on a lower side of the partition wall directly communicates with the heating chamber and an upper space on an upper side of the partition wall communicates with the heating chamber by way of the lower space,
an air introduction member that introduces air into the upper space, and
a gas outlet provided in the upper space.

3. The heat treatment furnace according to claim 2, wherein the air introduction member includes a plurality of air introduction parts, each being provided to extend in a conveying direction of the motor core and to extend toward the upper space by way of a space in the partition wall which connects the upper space and the lower space.

4. The heat treatment furnace according to claim 1, further comprising:
a flame curtain formation device at an upstream end of the degreasing chamber.

5. The heat treatment furnace according to claim 1, wherein the degreasing chamber further comprises a heat exchanger through which the converted gas generated by the converted gas generation device flows before flowing into the heating chamber.

6. The heat treatment furnace according to claim 1, further comprising:
a blower that is located on an upstream side of the degreasing chamber in a conveying direction of the motor core and that sends wind toward the motor core.

7. The heat treatment furnace according to claim 6, wherein the blower is provided to generate warm airflow with dissipated heat on the heat treatment furnace side in blowing.

8. The heat treatment furnace according to claim 1, further comprising:
a cooling chamber with which the heating chamber directly communicates and which is configured to cool the motor core that has passed through the heating chamber, by the converted gas as an in-furnace atmosphere gas.
